(19) United States
(12) Patent Application Publication
(10) Pub. No.: US 2003/0108270 A1
(43) Pub. Date: Jun. 12, 2003

(54) Visible light tracer for high power-carrying optical fibers

(76) Inventors: Robert K. Brimacombe, Ottawa (CA); Douglas Holden, Nepean (CA)

Correspondence Address: Stephan P. Georgiev, SMART & BIGGAR, Suite 3400, 1000 de la Gauchetiere Street West, Montreal, QC, H3B 4W5, CA

(21) Appl. No.: 10/002,287

(22) Filed: Dec. 5, 2001

(51) Int. Cl. G02B 6/26

(52) U.S. Cl. 385/15

(57) ABSTRACT

An optical transmission apparatus including a port for connection to an optical fiber for releasing non-visible laser light for transmission through the optical fiber. The optical transmission apparatus includes a visible light generator optically connected to the port for releasing at the port a visible light tracer for propagation in the optical fiber with the non-visible laser light.

### FIELD OF THE INVENTION

The invention relates to devices and methods of indicating the presence of non-visible laser light in an optical fiber using a visible light tracer.

### BACKGROUND OF THE INVENTION

In optical telecommunication systems, optical fibers often carry high power non-visible laser light. This high power non-visible laser light presents a danger to field technicians who may have to disconnect optical fibers for maintenance or diagnostic purposes, among others. If a technician disconnects an active optical fiber carrying a high power non-visible laser light, the laser light could injure the technician.

In the prior art, active fiber detection is performed using fiber bend tools that cause laser light to leak from the optical fiber. Then, an appropriate detector can be used to detect the presence of a laser light. However, these tools have the potential to initiate coating fires or “fiber fuses” on optical fibers.

Against this background, there exists a need to provide novel methods and devices to indicate the presence of non-visible laser light in an optical fiber.

### SUMMARY OF THE INVENTION

In a first broad aspect, the invention provides an optical transmission apparatus including a port for connection to an optical fiber. The port releases a non-visible laser light for transmission through the optical fiber. The optical transmission apparatus further includes a visible light generator optically connected to the port for releasing at the port a visible light tracer for propagation in the optical fiber with the non-visible laser light.

The advantage of the visible light tracer resides in its ability to readily point out to the technician that the optical fiber carries a non-visible laser light. When the non-visible laser light is a high-power non-visible laser light, this feature reduces the likelihood of injury to the technician. It should be expressly noted that the present invention is not limited to the use of a visible light tracer only in conjunction with high power non-visible laser light. The visible light tracer can also be used to indicate the presence of low-power non-visible laser light in the optical fiber, which is useful for diagnostic purposes, for example.

For the purpose of the present specification, non-visible laser light is laser light that would be impossible or very hard to see by a human eye if it escaped from the optical fiber. The non-visible laser light encompasses, non-visible signal laser light (laser light that conveys data), Raman pump laser light and a combination of non-visible signal laser light and Raman pump laser light, among others.

In most applications, the visible light tracer serves the purpose of visual indicator only. However, it is also possible to use the visual light tracer as a vehicle to convey a machine-readable signal.

The optical transmission apparatus can be any apparatus that performs operations or manipulations on laser light. In a specific example, the optical transmission apparatus is an optical amplifier.

In one possible example of implementation, one or more aspects of the visible light tracer are modulated according to the predetermined non-visible laser light transmission conditions. In particular, a change in one or more aspects of the visible light tracer is effected when one or more predetermined non-visible laser light transmission conditions are met.

In one example, the intensity of the visible light tracer is modulated. In a first variant, the intensity modulation is such that the visual light tracer is present only when non-visible laser light exists in the optical fiber. When no non-visible laser light is present, the visible light tracer is turned off. In a second variant, a very low intensity, yet visible, visible light tracer is injected in the optical fiber when no non-visible laser light is present. Advantageously, this feature confirms the integrity of the optical path from the visible light generator to an observation point. When non-visible laser light is present in the optical fiber the intensity of the visible light tracer is increased. In yet another variant, the intensity modulation is such that the visible light tracer is pulsed at different frequencies (where the pulsation difference is distinguishable by the eye) to visually indicate the presence or absence of non-visible laser light.

In a second example, the color of the visible light tracer is modulated. For example, a visible light tracer of a first color, say green, indicates the absence of non-visible laser light while a visible light tracer of a second color, say red, indicates the presence of non-visible laser light.

In a first example of implementation, the transition from the absence to the presence of non-visible laser light in the optical fiber constitutes a predetermined non-visible laser light transmission condition that triggers a change in a certain aspect of the visible light tracer, say the intensity or the color. In another example of implementation, the predetermined non-visible laser light transmission condition relates to the power level of the non-visible laser light. Specifically, a predetermined non-visible laser light transmission condition that triggers a change in one or more aspects of the visible light tracer is met when the power of the non-visible laser light increases over a predetermined threshold. For example, a visible light tracer turned off indicates the absence of non-visible laser light, a first visible light tracer intensity indicates a low power non-visible laser light and a second, higher, visible light tracer intensity indicates a non-visible higher power laser light.

The visible light tracer can be a laser light or any other light which can be propagated through an optical fiber such as incandescent or fluorescent light emanating respectively form an incandescent or fluorescent light source. Another possibility is that the visible light tracer is light emitted by a Light Emitting Diode (LED).

In a second broad aspect, the invention provides a laser light monitor, which has an input for receiving a control signal indicating the occurrence of at least one predetermined non-visible laser light transmission condition in an optical fiber. The laser light monitor also has a visible light generator coupled to the input, the visible light generator being responsive to the control signal to generate a visible light tracer when a predetermined non-visible laser light transmission condition occurs in the optical fiber. The visible light tracer is injected in the optical fiber through an output, which is optically coupled to the visible light generator.

The laser light monitor can be used to inject the visible light tracer in the optical fiber at a point downstream of the non-visible laser light generator. In one specific example of implementation, the laser light monitor taps a portion of the non-visible laser light. Then, a detector processes the portion of the non-visible laser light to determine if a predetermined non-visible laser light transmission condition exists in the optical fiber. When the predetermined non-visible laser light transmission condition is met, a visible light tracer is injected in the optical fiber.

In a third broad aspect, the invention provides an optical fiber transmitting simultaneously a non-visible laser light and a visible light tracer.

In a fourth broad aspect, the invention provides an optical transmission apparatus comprising a port for conveying light, the light including non-visible laser light and a visible light tracer produced by a visible light generator. An indicator is optically coupled to the visible light generator, the indicator glowing in response to visible light tracer to provide a visual indication that the visible light generator and hence the non-visible light generator are in operation.

### BRIEF DESCRIPTION OF THE DRAWINGS

A detailed description of examples of implementation of the present invention is provided hereinbelow with reference to the following drawings, in which:

FIG. 1 is a block diagram of an optical transmission system;

FIG. 2 is a block diagram of an optical amplifier of the transmission system shown at FIG. 1; and

FIG. 3 is a block diagram of a laser light monitor connected to an optical fiber.

In the drawings, embodiments of the invention are illustrated by way of example. It is to be expressly understood that the description and drawings are only for purposes of illustration and as an aid to understanding, and are not intended to be a definition of the limits of the invention.

### DETAILED DESCRIPTION

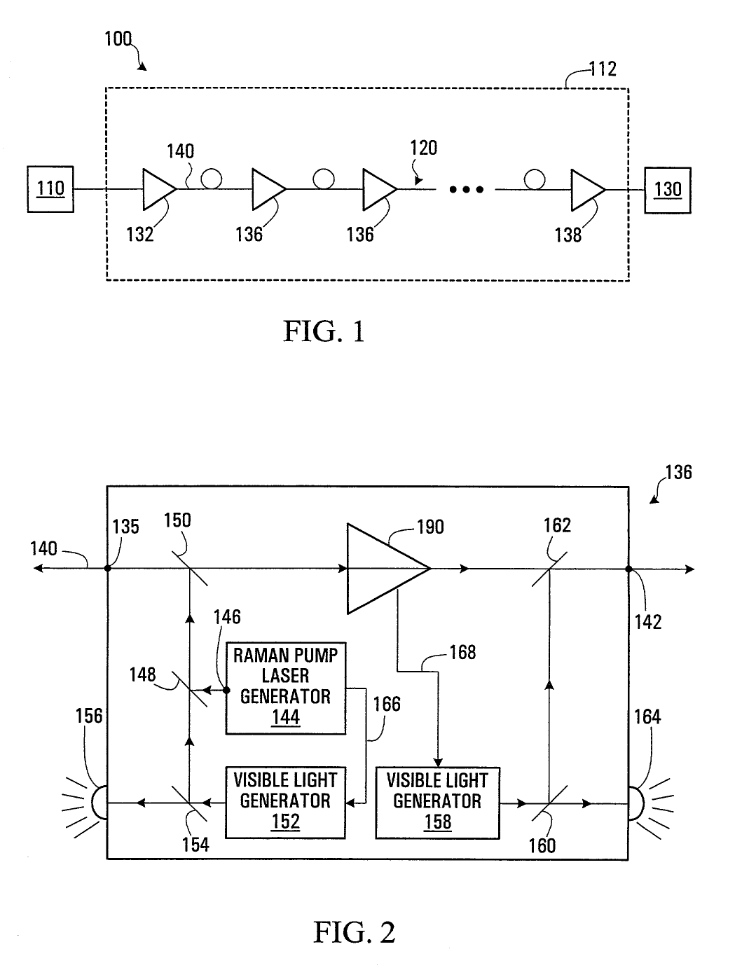

FIG. 1 shows an optical transmission system 100 that can be used in conjunction with the present invention. The optical transmission system 100 is a multi-span optically amplified WDM system that comprises one or more terminal transmitters 110 connected by an optical pathway 112 to one or more terminal receivers 130. The optical pathway 112 has a launch amplifier 132 that inputs in an optical transmission fiber 140 a high-power non-visible signal laser light conveying any type of data such as video, audio, or other. The optical pathway 112 includes a plurality of line amplifiers 136 that amplify the non-visible signal laser light. The optical pathway 112 ends with a receive amplifier 138 that outputs the signal to the terminal receivers 130.

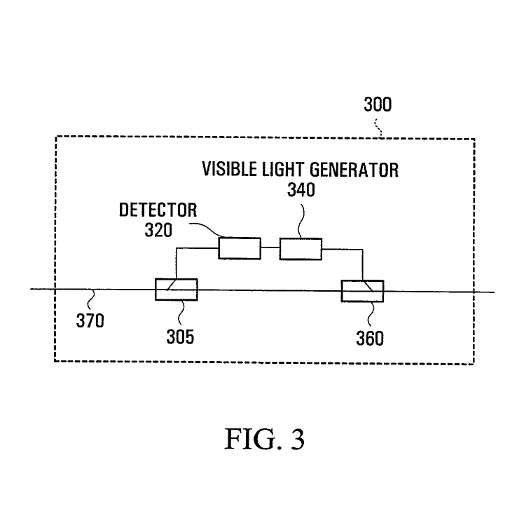

FIG. 2 shows the line amplifier 136 in greater detail. The line amplifier 136 has an input port 135 connecting to the transmission fiber 140 to receive the non-visible laser light. An optical amplifier 190 amplifies a signal conveyed by the non-visible signal laser light and generates an amplified non-visible signal laser light at its output. The output of the amplifier 190 is coupled to the output port 142 of the line amplifier 136 through which the amplified non-visible signal laser light is released. A Raman pump laser generator 144 produces a high power Raman pump laser light at its output 146. The output 146 is optically coupled through couplers 148 and 150 to inject the high power Raman pump laser light in the optical path leading to the optical amplifier 190 such that the high power Raman pump laser light is released through the input port 135 and propagates over the transmission fiber 140 in a direction opposite to the direction of propagation of the non-visible signal laser light. While the propagation of the high power Raman pump laser light is in a direction opposite to the direction of propagation of the non-visible signal laser light in the line amplifier 136, it is within the scope of the invention to have high power Raman pump laser light and non-visible signal laser light propagating in the same direction. In this case, the high power Raman pump laser light would be directed to the output port 142.

The line amplifier 136 also comprises a visible light generator 152 producing at its output a first visible light tracer that is passed through a splitter 154. The splitter 154 separates the first visible light tracer in two parts, one being directed to the coupler 148 and one being directed to an indicator 156 on the front panel of the line amplifier 136. The indicator 156 can be formed by the tip of an optical fiber allowing the first visible light tracer to be seen. The part of the first visible light tracer that is directed to the coupler 148 is combined with the high power Raman pump laser light into a combined radiation stream. The resulting combined radiation stream appears at the input port 135 as discussed earlier.

The line amplifier 136 also includes a second visible light generator 158 producing at its output a second visible light tracer that is passed through a splitter 160. The splitter 160 separates the second visible light tracer in two parts, one being directed to a coupler 162 and one being directed to an indicator 164, identical to the indicator 156, on the rear panel of the line amplifier 136. The part of the second visible light tracer that is directed to the coupler 162 is combined with the high power signal laser light released from the optical amplifier 140 into a combined radiation stream. The resulting combined radiation stream appears at the output 142.

The Raman pump laser generator 144 includes an output, which releases a first electrical control signal conveying information about at least one predetermined Raman pump laser light transmission condition. The first electrical control signal is transmitted to the visible light generator 152 through an electrical path 166. Depending on the particular application, the first electrical control signal conveys information signaling the transition from the absence to the presence of Raman pump laser light in the optical transmission fiber 140, or a variation in the power level of the Raman pump laser light.

In a similar manner, the optical amplifier 190 includes an output, which releases a second electrical control signal conveying information about at least one high power non-visible laser light transmission condition. The second electrical control signal is transmitted to the visible light generator 158 through an electrical path 168. Depending on the particular application, the second electrical control signal conveys information signaling the transition from the absence to the presence of high-power non-visible signal laser light in the optical transmission fiber 140, or a variation in the power level of the non-visible signal laser light.

In a non-limiting example of implementation, the visible light generators 152 and 158 are lasers emitting red laser light. The generation of a red laser light by the visible light generators 152 and 158 is preferred because this type of light usually presents the best fiber propagation characteristics. Alternatively, the visible light generators 152 and 158 can be any light source that generates respectively first and second visible light tracers that can be injected in the transmission fiber 140. Examples of such light sources include, but are not limited, to an incandescent light source, a Light Emitting Diode (LED) or a fluorescent light source.

In one possible example of implementation, the visible light generator 152 modulates the intensity of the first visible light tracer in dependence upon the information contained in the first electrical control signal received over the electrical paths 166. In a first variant, the intensity modulation is such that the visual light tracer is produced only when the first electrical control signal indicates that high power Raman pump laser light is being generated. When no high power Raman pump laser light is generated, the first visible light tracer is turned off. In a second variant, a low intensity, yet visible, first visible light tracer is generated when the first electrical control signal indicates that no Raman pump laser light is output. Advantageously this feature confirms the integrity of the optical path from the line amplifier 136 to an observation point. When Raman pump laser light is produced, the intensity of the first visible light tracer is increased.

In another possible variant, no first visible light tracer is output when no Raman pump laser light is present, a first visible light tracer of a first intensity is injected when a low power Raman pump laser light is present and a first visible light tracer of a higher intensity is injected when a high power Raman pump laser light is present. In yet another possible variant, the intensity modulation is such that the first visible light tracer is pulsed at different frequencies (where the pulsation difference is distinguishable by the eye) to visually indicate the presence or absence of Raman pump laser light. For instance, the first visible light tracer oscillates between a low intensity and a high intensity at a first frequency when no Raman pump laser light is present in the optical fiber. When a Raman pump laser light is present in the fiber, the frequency of oscillation increases.

In a second example of implementation, the color of the visible tracer is modulated. For example, a first visible light tracer of a first color, say green, indicates the absence of Raman pump laser light while a first visible light tracer of a second color, say red, indicates the presence of Raman pump laser light.

The modulation of the second visible light tracer produced by the visible light generator 158 can be done in the same manner as with the visible light generator 152.

In most applications, the first and the second visible light tracers carry no machine-readable signal. In other words, the first and second visible light tracers only serve the purpose of visually indicating a certain predetermined non-visible laser light transmission condition. However, it is within the scope of this invention to use the first or second visible light tracers, or both the first and the second visible light tracers, as a vehicle to covey a machine-readable signal containing data.

FIG. 3 shows a laser light monitor 300 for introducing a third visible light tracer in an optical fiber 370 when at least one predetermined non-visible laser light transmission condition in the optical fiber 370 is met. The laser light monitor 300 presents the advantage that it can be used downstream of a terminal transmitter where a non-visible signal laser light has been generated or downstream of a Raman pump laser generator where a Raman pump laser light has been generated.

The laser light monitor 300 comprises a splitter 305, a detector 320, a visible light generator 340 and a coupler 360. The splitter 305 taps a portion of the non-visible laser light propagating in the optical fiber 370. The detector 320 senses the tapped portion of the non-visible laser light and generates a third electrical control signal indicative of the occurrence of at least one predetermined non-visible laser light transmission condition. This type of monitor is known in the art and no detailed description of component is necessary. As mentioned previously for the fisrt and second electrical control signals, the third electrical control signal can convey information about the presence or the absence of non-visible laser light and about the power level of the non-visible laser light, among other possible predetermined non-visible laser light transmission conditions.

The third electrical control signal is received by the visible light generator 340, which is identical to the visible light generator 152 or 158, so that a third visible light tracer can be modulated in accordance to one or more predetermined non-visible laser light transmission conditions. The coupler 360 combines the non-visible laser light propagating in the optical fiber 370 and the third visible light tracer provided by the laser light generator 340 to provide a combined radiation stream. The coupler 360 is identical to the couplers 148 and 150.

Examples of predetermined non-visible laser light transmission conditions and of modulation of the third visible light tracer are described herein above in relation with the description of the line amplifier 136, the third visible light tracer being modulated similarly to the first and second visible light tracers.

The first, second or third visible light tracer injected by the laser light monitor 300 or the line amplifier 136 in the optical fiber 370 or 140 is used to indicate the presence of a possibly harmful non-visible laser light in the optical fiber 370 or 140. If the optical fiber 370 or 140 is coated with a coating having a significant transmittance to light having the wavelength of the visible light tracer, the presence of the first, second or third visible light tracer can be monitored simply by bending the optical fiber 370 or 140. In this case, some of the first, second or third visible light tracer will escape the optical fiber 370 or 140 through the macrobend loss phenomenon. Alternatively, only a portion of the optical fiber 370 or 140 needs to be covered by a coating transparent to the first, second or third visible light tracer.

Although various embodiments have been illustrated and described, this was for the purpose of describing, but not limiting, the invention. Various modifications will become apparent to those skilled in the art and are within the scope of this invention, which is defined more particularly by the attached claims.

1) An optical transmission apparatus including a port for connection to an optical fiber for releasing non-visible laser light for transmission through the optical fiber, said optical transmission apparatus including a visible light generator optically coupled to said port for releasing at said port a visible light tracer for propagation in the optical fiber with the non-visible laser light, wherein said visible light generator modulates at least one aspect of the visible light tracer when at least one predetermined non-visible laser light transmission condition in the optical fiber is met.

2) An optical transmission apparatus as defined in claim 1, wherein said visible light generator modulates an intensity of the visible light tracer.

3) An optical transmission apparatus as defined in claim 1, wherein said visible light generator modulates a color of the visible light tracer.

4) An optical transmission apparatus as defined in claim 1, wherein said predetermined non-visible laser light transmission condition is a transition from absence of non-visible laser light in the optical fiber to presence of non-visible laser light in the optical fiber.

5) An optical transmission apparatus as defined in claim 1, wherein said predetermined non-visible laser light transmission condition is a transition from a first power level of the non-visible laser light to a second power level of the non-visible laser light.

6) An optical transmission apparatus as in claim 1, comprising a non-visible laser light generator for generating the non-visible laser light, said non-visible laser light generator being optically coupled to said port.

7) An optical transmission apparatus as defined in claim 6, wherein said non-visible laser light generator is a Raman pump laser light generator.

8) An optical transmission apparatus as defined in claim 6, wherein said non-visible laser light generator is an amplifier producing a non-visible signal laser light.

9) An optical transmission apparatus as defined in claim 1 wherein the visible light tracer carries a machine-readable signal.

10) A laser light monitor, comprising:
a) an input for receiving a control signal indicating the occurrence of at least one predetermined non-visible laser light transmission condition in an optical fiber;
b) a visible light generator coupled to said input to modulate at least one aspect of a visible light tracer in response to the control signal;
c) a coupler including a first input coupled to said visible light generator for receiving the visible light tracer and a second input coupled to the optical fiber for receiving the non-visible laser light, said coupler further including an output, said coupler being operative to combine the visual light tracer and the non-visible laser light into a combined radiation stream and release the combined radiation stream at said output.

11) A laser light monitor as defined in claim 10, wherein said visible light generator modulates an intensity of the visible light tracer.

12) A laser light monitor as defined in claim 10, wherein said visible light generator modulates a color of the visible light tracer.

13) A laser light monitor as defined in claim 10, wherein the predetermined non-visible laser light transmission condition is a transition from absence of non-visible laser light in the optical fiber to presence of non-visible laser light in the optical fiber.

14) A laser light monitor as defined in claim 10, wherein the predetermined non-visible laser light transmission condition is a transition from a first power level of the non-visible laser light to a second power level of the non-visible laser light.

15) A laser light monitor as defined in claim 10 comprising a detector for sensing the non-visible laser light in the optical fiber and generating an electrical control signal, said detector including an output for releasing the electrical control signal to said visible light generator.

16) An optical fiber transmitting simultaneously a non-visible laser light and a visible light tracer, wherein the non-visible laser light includes Raman pump laser light.

17) An optical transmission apparatus, comprising:
a) a port for conveying light, the light including non-visible laser light and a visible light tracer;
b) a visible light generator for producing the visible light tracer, said visible light generator being optically coupled to said port for transmitting the visible light tracer to said port;
c) an indicator optically coupled to said visible light generator, the indicator glowing when the visible light tracer is produced by said visible light generator.
